(19) United States
(12) Patent Application Publication
(10) Pub. No.: US 2019/0136898 A1
(43) Pub. Date: May 9, 2019

(54) SELF-TAPPING SCREW WITH DRILLING WING

(71) Applicant: CHUN YU WORKS & CO., LTD., KAOHSIUNG CITY (TW)

(72) Inventor: CHIN-FENG SHEN, KAOHSIUNG CITY (TW)

(21) Appl. No.: 15/806,715

(22) Filed: Nov. 8, 2017

(51) Int. Cl. F16B 25/10

(52) U.S. Cl. CPC F16B 25/103

(57) ABSTRACT

A self-tapping screw with drilling wing includes a head, a shank extending therefrom, a plurality of threads spirally disposed on the shank, a drilling portion opposite to the head, and at least one winged reaming unit formed on the drilling portion and extending outwards therefrom. At least one supporting rib protrudes from at least one surface of the reaming unit for increasing the strength of the reaming unit, allowing the reaming unit to bear the larger drilling stress during a screwing operation and provide the greater cutting action, and preventing the reaming unit from wearing or breaking. The combination of the supporting rib and the reaming unit allows the reaming unit to provide a suitable thickness which facilitates a preferable cutting speed without affecting the drilling capability of the screw.

### BACKGROUND OF THE INVENTION

### 1. Field of the Invention

This invention relates to a self-taping screw and relates particularly to a self-tapping screw with drilling wing capable of executing screwing speedily.

### 2. Description of the Related Art

Referring to FIG. 1, a conventional fastener 1 comprises a head 11, a shank 12 extending downwards from the head 11, a plurality of threads 13 spirally disposed on the shank 12, a drilling portion 14 connected to an end of the shank 12, and two reaming units 15 symmetrically disposed on the drilling portion 14. When the conventional fastener 1 is applied to screw a wood object 21 to a metal object 22, the drilling portion 14 is rendered to touch a surface of the wood object 21 first. Then, the rotation force is applied to the head 11 to carry out the cutting action of the drilling portion 14 so that the drilling portion 14 starts cutting the wood object 21 to form a hole 211 in the wood object 2. Simultaneously, the reaming units 15 follow the drilling portion 14 to enter into the hole 211 and execute reaming. Thus, the threads 13 gradually penetrate into the wood object 21 via the hole 211. When the drilling portion 14 reaches the metal object 22, the drilling portion 14 continues cutting the metal object 22 to move the reaming units 15 downwards. When the reaming units 15 reach the metal object 22 to execute the reaming operation thereof, the reaming units 15 snap owing to the larger drilling stress derived from cutting the metal object 2. Consequently, the threads 13 take the place of the reaming units 15 to cut and screw the wood object 21 to the metal object 22 whereby the screwing operation of the conventional fastener 1 is completed.

Therefore, the thickness of the reaming units 15 should be controlled precisely while forming the conventional fastener 1. If the thickness of the reaming units 15 is too small to bear the drilling stress derived from reaming the wood object 21, the reaming units 15 snap, with the result that the reaming operation of the wood object 21 is executed ineffectively, as shown in FIG. 2. Further, cut chips accumulate between the threads 13. Consequently, the cut chips hinder the threads 13 from screwing into the wood object 21 to result in the reduced screwing speed of the conventional fastener 1. On the other hand, if the thickness of the reaming units 15 is more than enough, the reaming units 15 become too strong to break. Although the reaming units 15 are able to execute the reaming operation of the wood object 21, the reaming units 15 hinder the conventional fastener 1 from screwing into the metal object 22 when the reaming units 15 cut the metal object 22 ineffectively and block up the hole 211, as shown in FIG. 3. On the contrary, if the reaming units 15 screw into the metal object 22, the conventional fastener 1 engages with the metal object 22 loosely to result in the reduced screwing effect.

Generally, the reaming units 15 are formed by stamping an end of the shank 12 via two stamping dies (not shown) so that parts of the shank 12 are pressed to extend outwards to form the reaming units 15 and the drilling portion 14. Therefore, in order to form the reaming units 15 successfully with the suitable thickness, an adjustment of the space between the stamping dies is important. Accordingly, the forming operation of the reaming units 15 is strict. If the space is over small, the reaming units 15 are formed with insufficient thickness, with the result that the reaming units 15 are too weak to cut the wood object 2 effectively. On the contrary, if the space is over large, the reaming units 15 are formed with greater thickness, with the result that the reaming units 15 hinder the conventional fastener 1 from screwing into the metal object 22 or engaging with the metal object 22 tightly. Furthermore, the reaming units 15 formed with the increased thickness weaken the strength of the drilling portion 14 because more parts of the drilling portion 14 are taken to increase the thickness of the reaming units 15. Thus, the conventional fastener 1 still needs to be improved.

### SUMMARY OF THE INVENTION

The object of this invention is to provide a self-tapping screw with drilling wing capable of accelerating a screwing operation.

The self-tapping screw with drilling wing of this invention comprises a head, a shank extending downwards therefrom, a plurality of threads spiraled on the shank, a drilling portion connected to an end of the shank and opposite to the head, and at least one winged reaming unit extending outwards from the drilling portion. At least one supporting rib protrudes from at least one surface of each reaming unit, thereby enhancing the strength of the reaming unit effectively, allowing the reaming unit to provide the suitable thickness which facilitates a preferable cutting speed, preventing the reaming unit from wearing or breaking when cutting a wood object, and preventing the screwing capability of the self-tapping screw for cutting a metal object from affecting.

Preferably, the supporting rib extends in a direction different from an axis of the shank.

Preferably, the supporting rib is connected to an outer periphery of the reaming unit.

### BRIEF DESCRIPTION OF THE DRAWINGS

FIG. 1 is a schematic view showing a conventional fastener;

FIG. 2 is a schematic view showing that reaming units of the conventional fastener snap when reaming a wood object;

FIG. 3 is a schematic view showing that reaming units of the conventional fastener obstruct a screwing operation;

FIG. 4 is a schematic view showing a first preferred embodiment of this invention;

FIG. 4A is a perspective view showing a partial element of FIG. 4;

FIG. 5 is a schematic view showing that reaming units cut a wood object;

FIG. 6 is a schematic view showing that reaming units reach a metal object; and

FIG. 7 is a schematic view showing that reaming units snap to allow the self-tapping screw to penetrate and engage with the metal object.

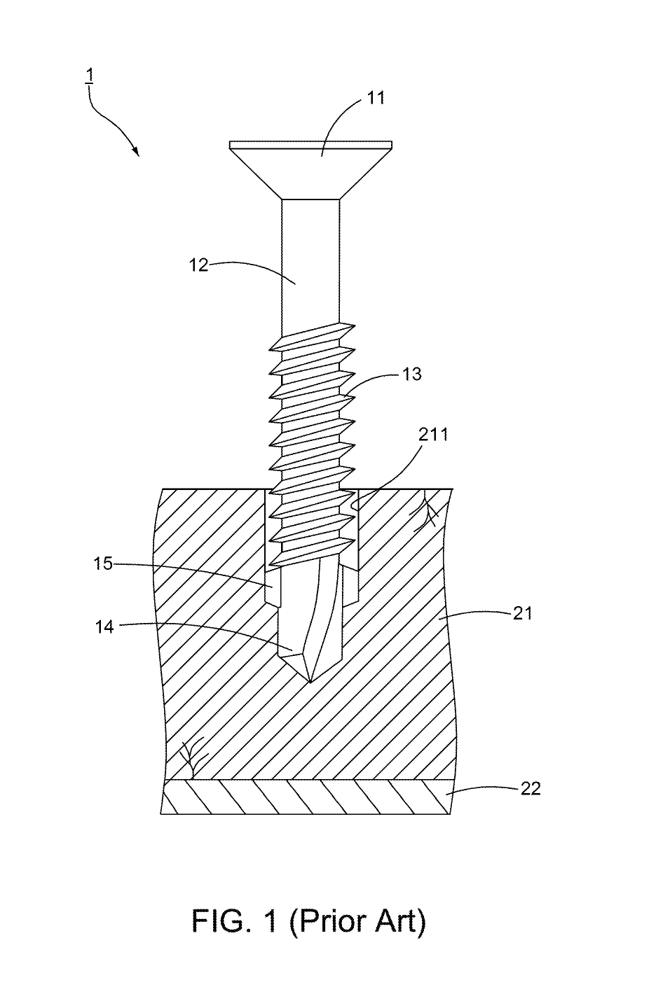

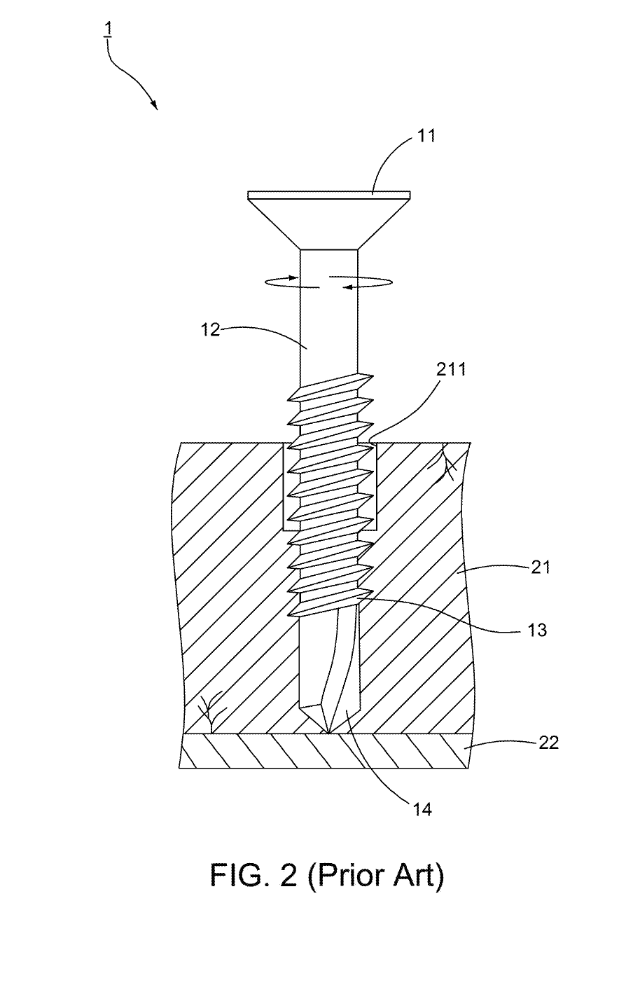

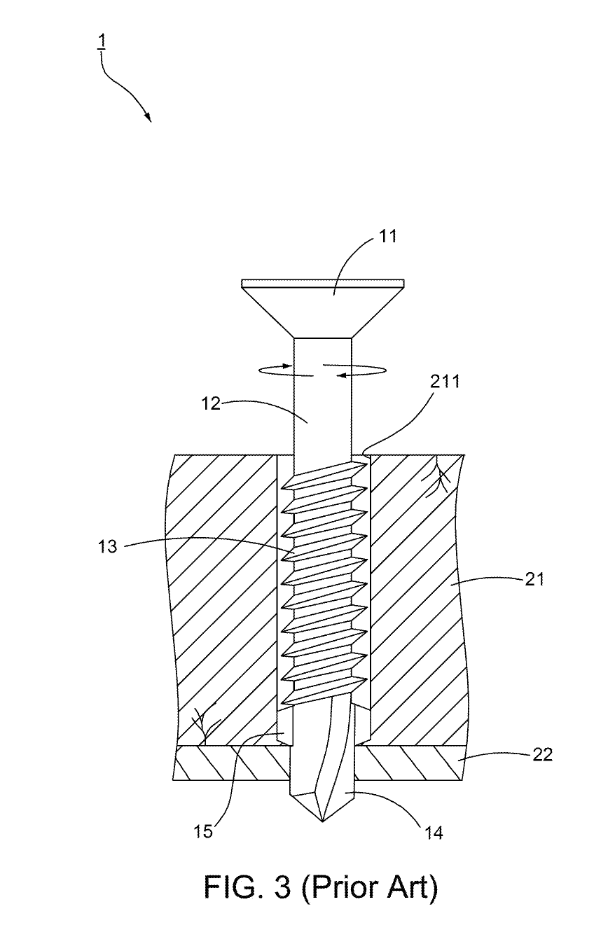

### DETAILED DESCRIPTION OF THE PREFERRED EMBODIMENTS

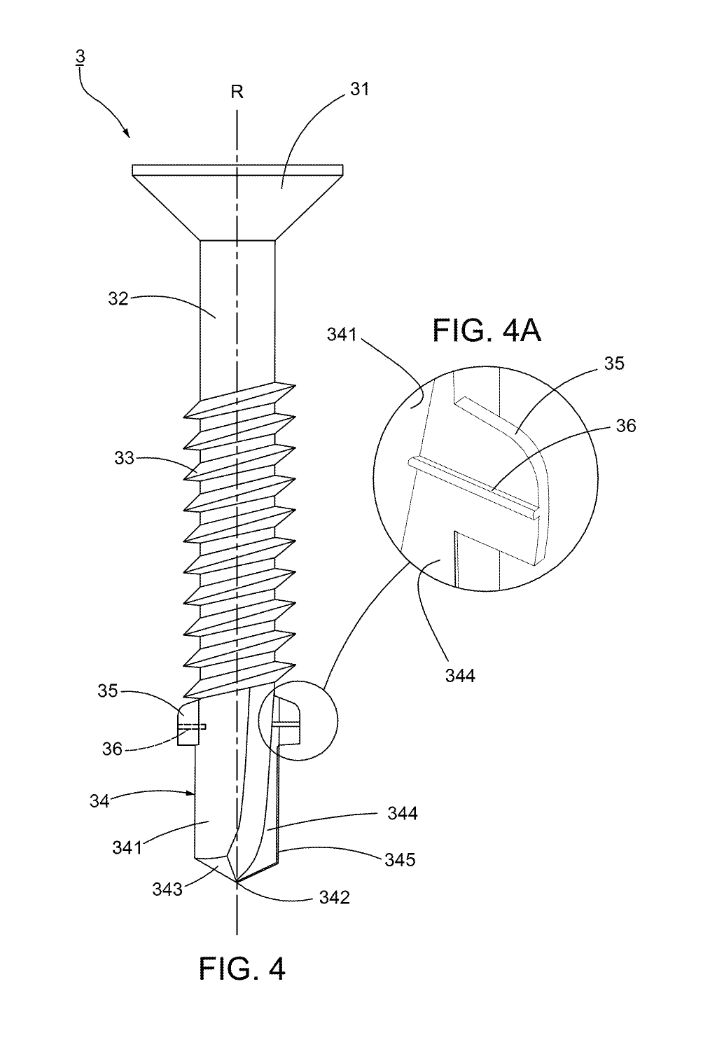

Referring to FIG. 4, a first preferred embodiment of a self-tapping screw 3 with drilling wing of this invention is disclosed. The self-tapping screw 3 includes a head 31, a shank 32 extending downwards from the head 31, a plurality of threads 33 spirally disposed on the shank 32, a drilling portion 34 fitted at an end of the shank 32 and opposite to the head 31, and at least one reaming unit 35 fitted on the drilling portion 34. The drilling portion 34 has a drilling body 341 connected to the shank 32 and tapering off to a tip 342, a drilling blade 343 formed at an end of the drilling body 341 and connected to the tip 342, two evacuation flutes 344 relative to each other and recessed on opposite sides of the drilling body 341, and two cutting edges 345 each of which is formed at a convergence of each evacuation flute 344 and the drilling body 341. The winged reaming unit 35 extends outwards from the drilling body 341. Referring to FIG. 4A, at least one supporting rib 36 projects from at least one surface of the reaming unit 35. Here takes an example that there are two reaming units 35 formed on the drilling portion 34 and each reaming unit 35 has one supporting rib 36 extending in a direction different from an axis R of the shank 32.

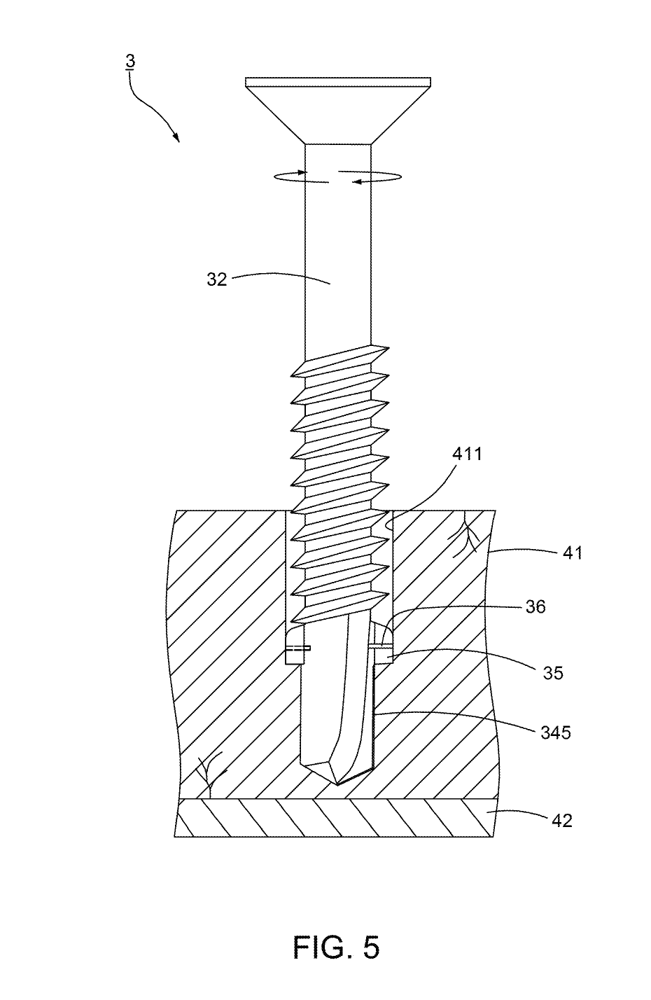

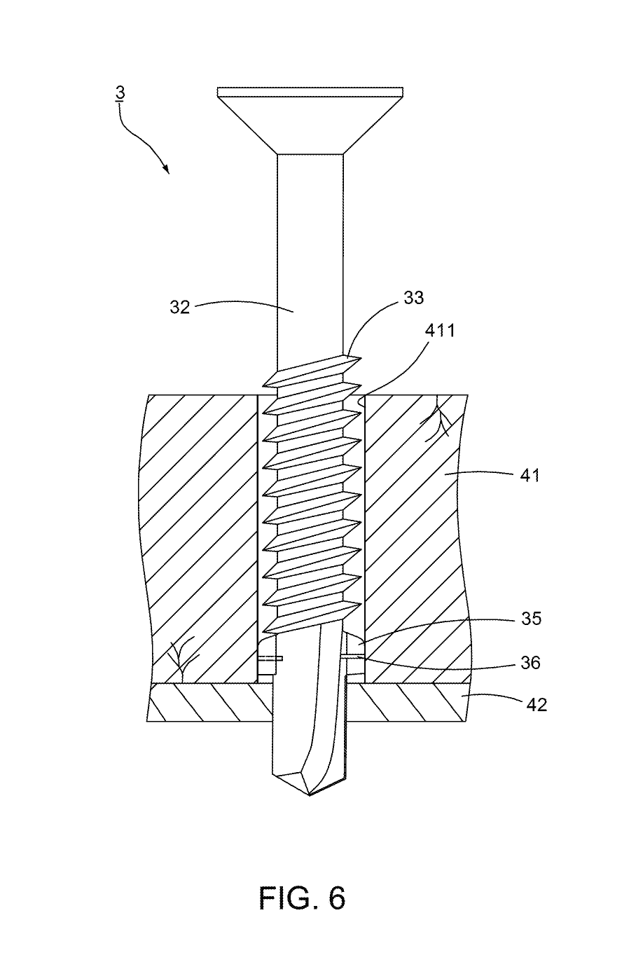

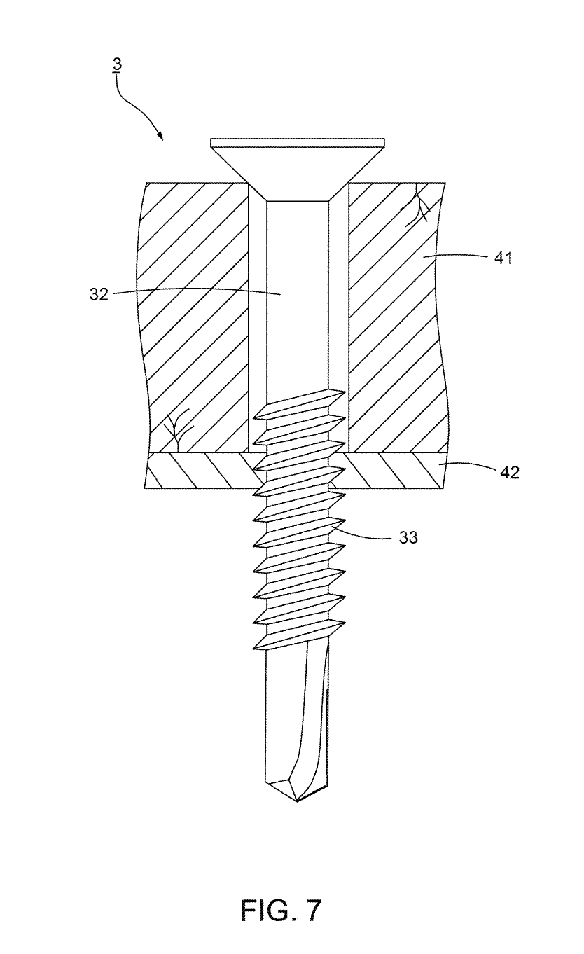

Referring to FIG. 4 and FIG. 5, the self-tapping screw 3 is aimed at screwing an object to a metal object, such as steel structures or iron plates. Here takes an example that the self-tapping screw 3 is applied to screw a wood object 41 to a metal object 42. During the screwing operation of the self-tapping screw 3, the tip 342 of the drilling portion 34 is positioned against a surface of the wood object 41 firstly. Then, the head 31 receives the rotation force to carry out the cutting action of the cutting edges 345 of the drilling portion 34 to cut a hole 411 in the wood object 41. When the drilling portion 34 gradually moves downwards into the hole 411, the reaming unit 35 starts reaming the hole 411. Because the reaming unit 35 is provided with the supporting rib 36 formed thereon, the supporting rib 36 can sustain the reaming unit 35 whereby the strength of the reaming unit 35 is increased to execute the cutting and reaming operation of the wood object 41 smoothly. Further, with the support of the supporting rib 36, the reaming unit 35 can be formed with smaller thickness to increase the sharpness and enhance the cutting capability while maintaining enough strength for cutting the wood object 41. Referring to FIG. 6 to FIG. 7, when the reaming unit 35 contacts the metal object 42, the reaming unit 35 snaps immediately because the reaming unit 35 is formed with smaller thickness and the support of the supporting rib 36 is insufficient forbearing the drilling stress derived from cutting the metal object 42. After the reaming unit 35 snaps, the drilling portion 34 and the threads 33 continue cutting the metal object 42 whereby the self-tapping screw 3 engages the wood object 41 with the metal object 42 effectively to achieve the preferable screwing effect.

Furthermore, the supporting rib 36 enhances the strength of the reaming unit 35, thereby allowing the reaming unit 35 to bear the larger drilling stress during the screwing operation, solving the problem of the insufficient strength of the reaming unit 35 caused by reducing the thickness of the reaming unit 35, and preventing the reaming unit 35 from breaking when executing the reaming operation of the wood object 41. Hence, the combination of the supporting rib 36 and the reaming unit 35 allows the reaming unit 35 to provide a suitable thickness. In other words, the reaming unit 35 can be formed with less thickness to increase the cutting speed while maintaining the sufficient strength for cutting the wood object 41. On the other hand, the reaming unit 35 breaks instantly when reaming the metal object 42. Besides, the reaming unit 35 is formed by pressing the drilling portion 34 whereby parts of the drilling portion 34 extend outwards to form the reaming unit 35. Hence, the strength of the drilling portion 34 is not weakened because the reaming unit 35 is formed thinner, namely, less parts of the drilling portion 34 in comparison of the conventional fastener 1 are taken to form the reaming unit 35. Therefore, the drilling potion 34 maintains the preferable strength. Thus, the production quality and the screwing capability of the self-tapping screw 3 are increased effectively.

To sum up, the self-tapping screw with drilling wing of this invention takes an advantage of at least one supporting rib formed on one surface of the reaming unit and extending outwards from the drilling body to increase the strength of the reaming unit, thereby allowing the reaming unit to bear larger drilling stress during the screwing operation, allowing the reaming unit to make thinner while keeping enough strength for cutting the wood object, preventing the reaming unit from wearing or breaking before reaching the metal object, and ensuring the preferable screwing effect of the self-tapping screw.

While the embodiments of this invention are shown and described, it is understood that further variations and modifications may be made without departing from the scope of this invention.

What is claimed is:

1. A self-tapping screw with drilling wing comprising a head, a shank extending downwards from said head, a plurality of threads spirally formed around said shank, a drilling portion connected to an end of said shank opposite to said head, and at least one reaming unit disposed on said drilling portion, wherein said drilling portion has a drilling body connected to said shank and tapering off to a tip, a drilling blade formed at an end of said drilling body connected to said tip, two evacuation flutes formed on opposite sides of said drilling body, and two cutting edges each formed at a convergence of each of said evacuation flutes and said drilling body, said at least one winged reaming unit extending outwards from said drilling body, at least one supporting rib projecting from at least one surface of said reaming unit to reinforce strength of said reaming unit.

2. The self-tapping screw with drilling wing as claimed in claim 1, wherein said at least one supporting rib extends in a direction different from an axis of said shank.

3. The self-tapping screw with drilling wing as claimed in claim 1, wherein said at least one supporting rib is connected to an outer periphery of said at least one reaming unit.

4. The self-tapping screw with drilling wing as claimed in claim 2, wherein said at least one supporting rib is connected to an outer periphery of said at least one reaming unit.
